(19) United States
(12) Patent Application Publication
(10) Pub. No.: US 2010/0003455 A1
(43) Pub. Date: Jan. 7, 2010

(54) System And Method For Preventing Vegetation

(76) Inventor: Ray Brien, Brighton, CO (US)

Correspondence Address: LATHROP & GAGE LLP, 4845 PEARL EAST CIRCLE, SUITE 201, BOULDER, CO, 80301, US

(21) Appl. No.: 12/497,614

(22) Filed: Jul. 3, 2009

Related U.S. Application Data
(60) Provisional application No. 61/078,244, filed on Jul. 3, 2008.

(51) Int. Cl. B32B 3/10; B32B 37/12

(52) U.S. Cl. 428/131; 156/71

(57) ABSTRACT

A vegetation prevention device and method includes a sheet of material having a thickness sufficient to stop vegetation growth. The sheet forms an aperture that fits about a cross section of the fencepost. An optional slit extends from the aperture to an outer rim of the sheet. Bending the sheet at the slit opens the sheet so that the fencepost may pass through the slit and the aperture may be arranged about the fencepost. Caulking may optionally be applied about the fencepost and/or to seal up the slit.

### RELATED APPLICATIONS

This Application claims priority to U.S. Provisional Patent Application Ser. No. 61/078,244, filed Jul. 3, 2008, which is incorporated herein by reference.

### BACKGROUND

Weeds and other vegetation often grow around fenceposts, sign posts, etc. In many cases it is desirable to keep the vegetation in these areas adjacent to fenceposts well maintained at a low, even height. Often, however, it is difficult to reach an area adjacent to fenceposts with maintenance equipment.

### SUMMARY OF THE INVENTION

In an embodiment, a vegetation prevention device includes a sheet of material having a thickness sufficient to stop vegetation growth, the sheet forming an aperture that fits about a cross section of the fencepost. An optional slit extends from the aperture to an outer rim of the sheet, such that bending the sheet at the slit opens the sheet so that the fencepost may pass through the slit and the aperture may be arranged about the fencepost.

In an embodiment, a method for preventing vegetation growth adjacent to a fencepost includes providing a vegetation preventing sheet that forms an aperture configured to fit about a base of the fencepost. A slit extends from the aperture to an outer rim of the vegetation prevention sheet. The sheet is opened by bending portions of the sheet adjacent to the slit to form an opening for the fencepost, and passing the fencepost through the opening. With the sheet aperture about the base of the fence post the sheet is then closed by bending the sheet so as to close the slit with the aperture about the base of the fencepost.

In an embodiment, a method for preventing vegetation growth adjacent to a fencepost includes providing a vegetation preventing sheet that forms an aperture configured to fit about a base of the fencepost. The method includes placing the aperture of the vegetation preventing sheet about the fencepost such that the vegetation preventing sheet lies on a ground surface adjacent to the fencepost.

### BRIEF DESCRIPTION OF THE FIGURES

FIG. 1 shows a perspective view of a section of fence with two vegetation prevention devices about corresponding fenceposts.

FIG. 2A is a plan view of a vegetation prevention device with removable sections about a square aperture.

FIG. 2B is a plan view of a vegetation prevention device with removable sections about a round aperture.

FIG. 3 is a plan view of a vegetation prevention device with removable sections.

### DETAILED DESCRIPTION OF THE FIGURES

A vegetation preventing system is described hereinbelow to provide a cost effective and simple way to prevent vegetation growth around a fencepost, signpost, or any other post around which vegetation is otherwise permitted to grow. Other advantages will become apparent to one skilled in the art upon reading and appreciating the following detailed description of the invention. In the following description, numerals in parentheses refer to specific instances of an item or element (e.g., devices 14(1) and 14(2)) while numerals without parentheses refer to any such items (e.g., device 14).

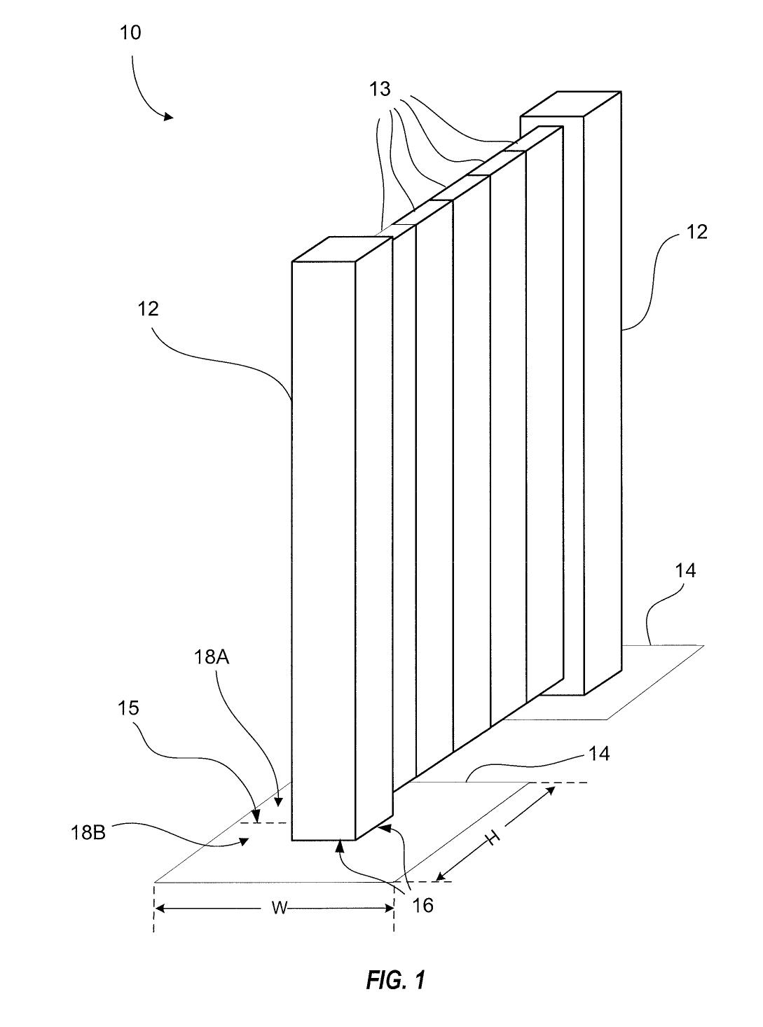

FIG. 1 shows a fencing section 10 with vegetation prevention devices 14. Fencing section 10 has fenceposts 12, as shown and planks 13. In use, each device 14 forms an aperture (not labeled in FIG. 1, for clarity of illustration) that fits about a cross section of the corresponding fencepost 12. As shown, the aperture is in the center of device 14, however the aperture may be formed at other locations within device 14.

Device 14 prevents growth of weeds and other vegetation on a ground surface adjacent to fencepost 12. Device 14 may be formed of plastic and/or other suitable materials sufficient to stop vegetation growth. For instance, in one embodiment, device 14 is formed of ⅛ inch thick corrugated plastic sheeting that may be sold under the trade name COROPLAST®. Device 14 can be constructed in various sizes. A width W and height H of device 14 may each be 6-28 inches, with larger W and H being appropriate for larger fenceposts 12. For instance, a 4×4 inch fencepost 12 with a sheet 12 may have a W and H of 12-28 inches, while a 2×2 inch fencepost 12 may have a W and H of 6-18 inches.

Device 14 is configured to fit about existing fencepost 12. In new fence construction, the aperture of device 14 is simply placed about fencepost 12 when fencepost 12 is originally placed and before further hardware is attached. For existing fences, an optional slit 15 (which can either be part of device 14 as manufactured, or generated by an installer by cutting from edge to center device 14) extends from the aperture to an outermost rim of device 14. Device 14 can be seen as having two portions 18A and 18B adjacent to slit 15. Bending or twisting portions 18A and 18B opens device 14 so that fencepost 12 can pass through an opening thus formed. Device 14 can be fitted snugly about fencepost 12 by twisting portions 18A and 18B back into proximity with each other.

Caulking may be applied to seal slit 15 and/or the aperture of device 14 where it meets fencepost 12 at inner rim 16. Sealing slit 15 and/or inner rim 16 with caulking helps to ensure that vegetation growth does not occur adjacent to fencepost 12 or at slit 15. For instance, in one embodiment, caulking may be applied the length of slit 15 and/or the circumference of inner rim 16.

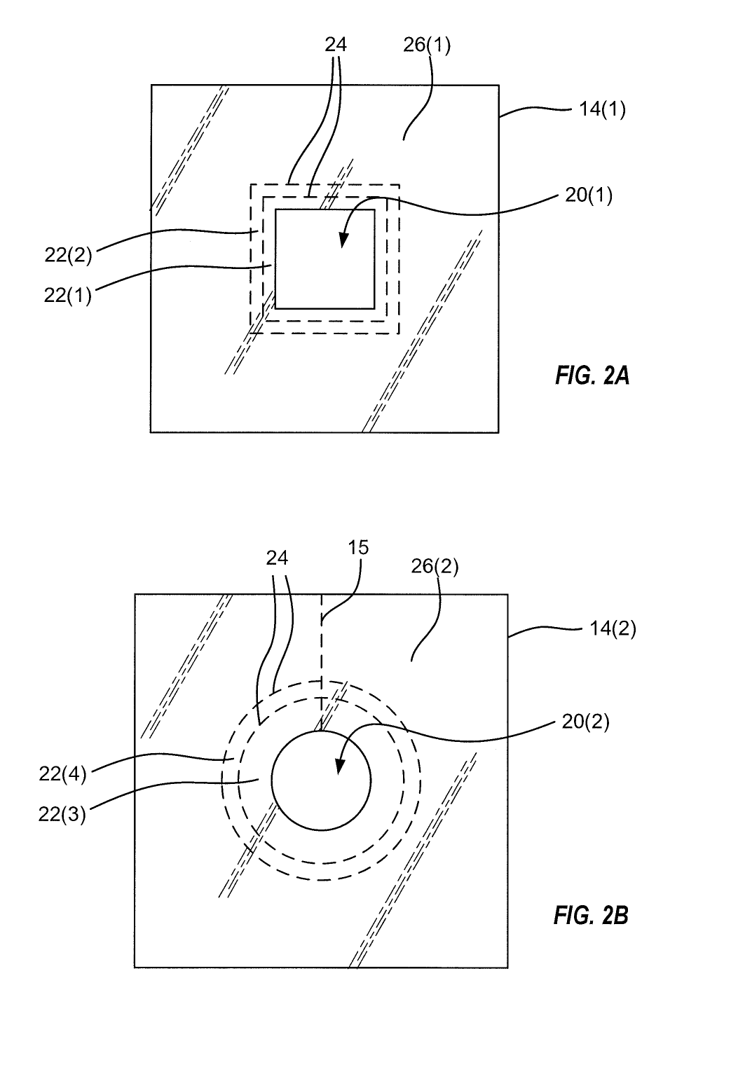

FIG. 2A is a plan view of a vegetation prevention device 14(1) with removable sections 22 about a square aperture 20(1). Perforations 24, along with aperture 20(1), define an inner removable section 22(1) and an outer removable section 22(2) that are formed of a common piece of material that also forms outer portion 26(1) of device 14(1). Sections 22 are selectively removable from device 14(1) by tearing along perforations 24, to enlarge aperture 20(1) for differently sized fenceposts. Similarly, FIG. 2B is a plan view of a vegetation prevention device 14(2) with removable sections 22 about a round aperture 20(2). Perforations 24, along with aperture 20(2), define an inner removable section 22(3) and an outer removable section 22(4) that are formed of a common piece of material that also forms outer portion 26(2) of device 14(2). Sections 22 are selectively removable from device 14(2) by tearing along perforations 24, to enlarge aperture 20(2) for differently sized fenceposts. Perforations 24 may be narrow enough that vegetation does not grow up through perforations 24 when sections 22 are not removed, or perforations 24 may be caulked upon installing devices 14(1) or 14(2), to stop vegetation growth therethrough. Vegetation prevention device 14(2) is also shown with a perforated slit 15 that may be torn by a user in order to fit device 14(2) about an existing post.

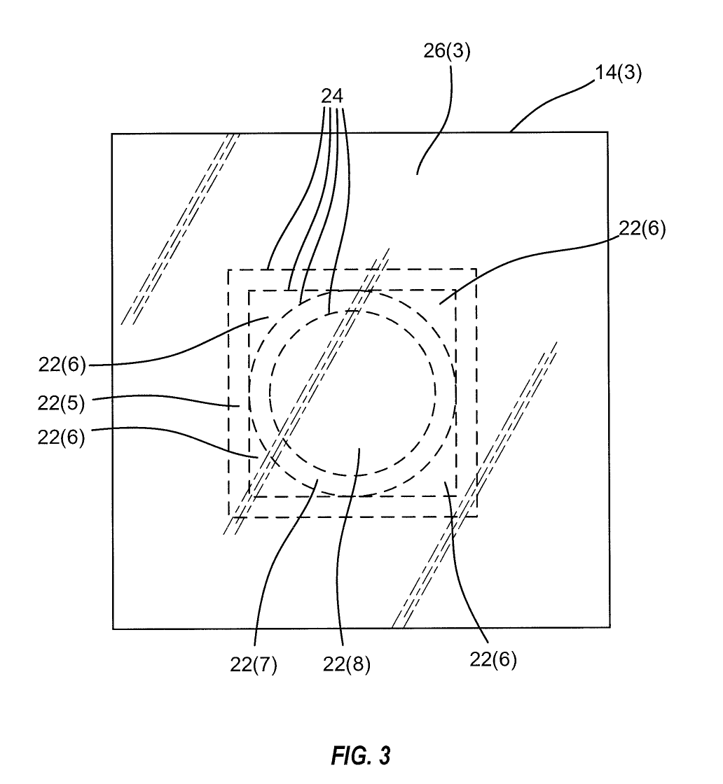

FIG. 3 is a plan view of a vegetation prevention device 14(3) with removable sections 22. Device 14(3) may be a square formed of COROPLAST or other suitable material formed as a square 12 inches on each side, with perforations 24 that define inner removable sections 22(5)-22(8), as shown. For ease of manufacturing, device 14(3) provides perforations 24 to create an aperture (that is, device 14(3) may be manufactured and shipped to a point of use before any of sections 22(5)-22(8) are removed). Removal of section 22(8) provides a round, 4 inch diameter aperture; removal of section 22(7) provides a round, 5 inch diameter aperture; removal of four sections 22(6) provides a square, 5 inch per side aperture; removal of section 22(5) provides a square, 6 inch per side aperture.

Changes may be made in the above systems and methods without departing from the scope hereof. For example, shapes and sizes of vegetation prevention devices may vary according to shapes and sizes of fenceposts, and for aesthetic reasons. Apertures may form square, circular, rectangular, oval or other shapes; outer edges of a vegetation prevention device may also form such shapes, with a shape of an outer edge not necessarily matching a shape of an aperture. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A vegetation prevention device for preventing vegetation growth adjacent to a fencepost, comprising a sheet of material having a thickness sufficient to stop vegetation growth, the sheet forming an aperture that fits about a cross section of the fencepost.

2. The vegetation prevention device of claim 1, further comprising a caulking sealant.

3. The vegetation prevention device of claim 1, wherein the caulking sealant is applied along the length of the slit from the aperture to the outer rim of the sheet.

4. The vegetation prevention device of claim 1, wherein the caulking sealant is applied along the circumference of the aperture adjacent to the aperture and the fencepost.

5. The vegetation prevention device of claim 1, wherein the material comprises corrugated plastic sheeting.

6. The vegetation prevention device of claim 1, wherein the thickness of the sheet is in the range of ⅛ inch.

7. The vegetation prevention device of claim 1, the sheet forming a slit extending from the aperture to an outer rim of the sheet, such that bending the sheet at the slit opens the sheet so that the fencepost may pass through the slit and the aperture may be arranged about the fencepost.

8. The vegetation prevention device of claim 7, further comprising a caulking sealant.

9. The vegetation prevention device of claim 7, wherein the caulking sealant is applied along the length of the slit from the aperture to the outer rim of the sheet.

10. The vegetation prevention device of claim 7, wherein the caulking sealant is applied along the circumference of the aperture adjacent to the aperture and the fencepost.

11. The vegetation prevention device of claim 7, wherein the material comprises corrugated plastic sheeting.

12. The vegetation prevention device of claim 7, wherein the thickness of the sheet is in the range of ⅛ inch.

13. The vegetation prevention device of claim 1, wherein the sheet forms perforations that define removable sections of the sheet for adjusting a size of the aperture.

14. The vegetation prevention device of claim 13, wherein one or more of the perforations define the aperture.

15. A method of preventing vegetation growth adjacent to a fencepost, comprising:
providing a vegetation preventing sheet that forms an aperture configured to fit about a base of the fencepost, the sheet having a slit extending from the aperture to an outer rim of the vegetation preventing sheet;
opening the vegetation preventing sheet by bending the sheet adjacent to the slit to form an opening for the fencepost;
passing the fencepost through the opening; and
closing the opening by bending the sheet so as to close the slit, with the aperture about the base of the fencepost.

16. The method of claim 15, further comprising applying caulking sealant about the aperture so as to seal the sheet to the fencepost.

17. The method of claim 15, further comprising applying caulking sealant along the slit so as to seal the sheet from the aperture to the outer rim.

18. The method of claim 15, wherein providing comprises tearing perforated sections of the sheet along perforations to create the aperture or to adjust a size of the aperture.

19. A method of preventing vegetation growth adjacent to a fencepost, comprising:
providing a vegetation preventing sheet that forms an aperture configured to fit about a base of the fencepost; and
placing the aperture of the vegetation preventing sheet about the fencepost such that the vegetation preventing sheet lies on a ground surface adjacent to the fencepost.
